(19) United States
(12) Patent Application Publication
(10) Pub. No.: US 2020/0126566 A1
(43) Pub. Date: Apr. 23, 2020

(54) METHOD AND APPARATUS FOR VOICE INTERACTION

(71) Applicant: Baidu Online Network Technology (Beijing) Co., Ltd., Beijing (CN)

(72) Inventor: Wenyu Wang, Beijing (CN)

(21) Appl. No.: 16/564,596

(22) Filed: Sep. 9, 2019

(30) Foreign Application Priority Data
Oct. 17, 2018 (CN) 201811209944.4

(51) Int. Cl. G10L 17/22; G10L 13/04; G10L 17/00; G10L 17/06

(52) U.S. Cl. CPC G10L 17/22; G10L 17/06; G10L 17/005; G10L 13/043

(57) ABSTRACT

Embodiments of the present disclosure provide a method and apparatus for voice interaction. A method may include: acquiring voice information input by a user; determining a response character matching the acquired voice information based on the acquired voice information; and responding to the acquired voice information using a voice recorded in advance for the response character or a voice synthesized based on a voice feature parameter of the response character.

### CROSS-REFERENCE TO RELATED APPLICATIONS

This application claims priority to Chinese Patent Application No. 201811209944.4, filed on Oct. 17, 2018, titled “Method and apparatus for voice interaction,” which is hereby incorporated by reference in its entirety.

### TECHNICAL FIELD

Embodiments of the present disclosure relate to the field of computer technology, and specifically to a method and apparatus for voice interaction.

### BACKGROUND

With the development of the artificial intelligence technology, smart voice devices, such as smart screen speakers and smart acoustics, are gradually being used by users. A user may interact with a smart voice device through voice, so that the smart voice device may respond based on the voice of the user. Currently, the response character used by the smart voice device is simple and fixed.

### SUMMARY

Embodiments of the present disclosure propose a method and apparatus for voice interaction.

In a first aspect, some embodiments of the present disclosure provide a method for voice interaction, including: acquiring voice information input by a user; determining a response character matching the acquired voice information based on the acquired voice information; and responding to the acquired voice information using a voice recorded in advance for the response character or a voice synthesized based on a voice feature parameter of the response character.

In some embodiments, the determining a response character matching the acquired voice information based on the acquired voice information, includes: determining, in response to recognizing that the acquired voice information includes a name defined in advance for a response character, the response character corresponding to the recognized name as the response character matching the acquired voice information.

In some embodiments, the name defined in advance for the response character includes a voice interaction wake-up word.

In some embodiments, the determining a response character matching the acquired voice information based on the acquired voice information, includes: acquiring attribute information of the user; and determining the response character matching the acquired voice information, based on the attribute information of the user and a preset corresponding relationship between attribute information and a response character.

In some embodiments, the acquiring attribute information of the user, includes: performing voiceprint recognition on the acquired voice information, and determining the attribute information of the user based on a recognition result.

In some embodiments, the acquiring attribute information of the user, includes: determining identification information of the user based on the acquired voice information; and querying user attribute information corresponding to the identification information of the user in a pre-stored user information set.

In some embodiments, the responding to the acquired voice information using a voice recorded in advance for the response character or a voice synthesized based on a voice feature parameter of the response character, includes: converting the acquired voice information into a text; determining a response text based on the converted text and a voice response logic preset for the response character; and responding to the acquired voice information, using a voice recorded in advance for the response character and containing the response text, or a voice synthesized based on the voice feature parameter of the response character and the response text.

In some embodiments, the determining a response character matching the acquired voice information based on the acquired voice information, includes: determining identification information of the user based on the acquired voice information; querying a response character corresponding to the determined identification information in a response character setting record representing a corresponding relationship between identification information and response characters; and determining the queried response character as the response character matching the acquired voice information.

In a second aspect, some embodiments of the present disclosure provide an apparatus for voice interaction, including: an acquiring unit, configured to acquire voice information input by a user; a determining unit, configured to determine a response character matching the acquired voice information based on the acquired voice information; and a responding unit, configured to respond to the acquired voice information using a voice recorded in advance for the response character or a voice synthesized based on a voice feature parameter of the response character.

In some embodiments, the determining unit is further configured to: determine, in response to recognizing that the acquired voice information includes a name defined in advance for a response character, the response character corresponding to the recognized name as the response character matching the acquired voice information.

In some embodiments, the name defined in advance for the response character includes a voice interaction wake-up word.

In some embodiments, the determining unit includes: an acquiring subunit, configured to acquire attribute information of the user; and a first determining subunit, configured to determine the response character matching the acquired voice information, based on the attribute information of the user and a preset corresponding relationship between attribute information and a response character.

In some embodiments, the acquiring subunit is further configured to: perform voiceprint recognition on the acquired voice information, and determine the attribute information of the user based on a recognition result.

In some embodiments, the acquiring subunit is further configured to: determine identification information of the user based on the acquired voice information; and query user attribute information corresponding to the identification information of the user in a pre-stored user information set.

In some embodiments, the responding unit includes: a converting subunit, configured to convert the acquired voice information into a text; a second determining subunit, configured to determine a response text based on the converted text and a voice response logic preset for the response character; and a responding subunit, configured to respond to the acquired voice information, using a voice recorded in advance for the response character and containing the response text, or a voice synthesized based on the voice feature parameter of the response character and the response text.

In some embodiments, the determining unit includes: a third determining subunit, configured to determine identification information of the user based on the acquired voice information; a querying subunit, configured to query a response character corresponding to the determined identification information in a response character setting record representing a corresponding relationship between identification information and response characters; and a fourth determining subunit, configured to determine the queried response character as the response character matching the acquired voice information.

In a third aspect, some embodiments of the present disclosure provide an electronic device, including: one or more processors; a storage apparatus, storing one or more programs thereon; and the one or more programs, when executed by the one or more processors, cause the one or more processors to implement the method according to the first aspect.

In a fourth aspect, some embodiments of the present disclosure provide a computer readable medium, storing a computer program thereon, the program, when executed by a processor, implements the method according to the first aspect.

The method and apparatus for voice interaction provided by the embodiments of the present disclosure, by acquiring voice information input by a user, then determining a response character matching the acquired voice information based on the acquired voice information, and finally responding to the acquired voice information using a voice recorded in advance for the response character or a voice synthesized based on a voice feature parameter of the response character, provide a voice interaction mechanism for determining a response character based on voice information, and enrich the voice interaction method.

### BRIEF DESCRIPTION OF THE DRAWINGS

After reading detailed descriptions of non-limiting embodiments with reference to the following accompanying drawings, other features, objectives and advantages of the present disclosure will become more apparent.

FIG. 1 is a diagram of an exemplary system architecture in which some embodiments of the present disclosure may be applied;

FIG. 2 is a flowchart of a method for voice interaction according to an embodiment of the present disclosure;

FIG. 3 is a schematic diagram of an application scenario of the method for voice interaction according to an embodiment of the present disclosure;

FIG. 4 is a flowchart of the method for voice interaction according to another embodiment of the present disclosure;

FIG. 5 is a schematic structural diagram of an apparatus for voice interaction according to an embodiment of the present disclosure; and

FIG. 6 is a schematic structural diagram of a computer system adapted to implement a server or a terminal of some embodiments of the present disclosure.

### DETAILED DESCRIPTION OF EMBODIMENTS

The present disclosure will be further described below in detail in combination with the accompanying drawings and the embodiments. It may be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should be noted that the embodiments in the present disclosure and the features in the embodiments may be combined with each other on a non-conflict basis. The present disclosure will be described below in detail with reference to the accompanying drawings and in combination with the embodiments.

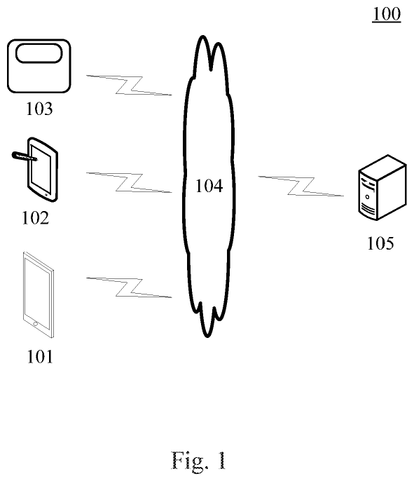

FIG. 1 illustrates an exemplary system architecture 100 of a method for voice interaction or an apparatus for voice interaction in which embodiments of the present disclosure may be applied.

As shown in FIG. 1, the system architecture 100 may include terminal devices 101, 102, 103, a network 104, and a server 105. The network 104 is used to provide a communication link medium between the terminal devices 101, 102, 103 and the server 105. The network 104 may include various types of connections, such as wired, wireless communication links, or optic fibers.

A user may interact with the server 105 through the network 104 using the terminal devices 101, 102, 103 to receive or send messages and the like. Various client applications, such as multimedia information playing applications, voice assistant applications, smart home applications, e-commerce applications, and search applications, may be installed on the terminal devices 101, 102, and 103.

The terminal devices 101, 102, 103 may be hardware or software. When the terminal devices 101, 102, and 103 are hardware, they may be various electronic devices having display screens, including but not limited to smart acoustics, smart screen speakers, smart phones, tablet computers, laptop portable computers, desktop computers, or the like. When the terminal devices 101, 102, 103 are software, they may be installed in the above-listed electronic devices. They may be implemented as a plurality of software programs or software modules (for example, software programs or software modules for providing an image acquiring service or a living body detection service), or as a single software program or software module, which is not specifically limited herein.

The server 105 may be a server that provides various services, such as a backend server that supports applications installed on the terminal devices 101, 102, and 103. The server 105 may acquire voice information input by a user; determine a response character matching the acquired voice information based on the acquired voice information; and respond to the acquired voice information using a voice recorded in advance for the response character or a voice synthesized based on a voice feature parameter of the response character.

It should be noted that the method for voice interaction provided by the embodiments of the present disclosure may be executed by the server 105, or may be executed by the terminal devices 101, 102, 103, accordingly, the apparatus for voice interaction may be disposed in the server 105, or may be disposed in the terminal devices 101, 102, and 103.

It should be noted that the server may be hardware or software. When the server is hardware, it maybe implemented as a distributed server cluster composed of a plurality of servers, or as a single server. When the server is software, it may be implemented as a plurality of software programs or software modules (for example, software programs or software modules for providing distributed services) or as a single software program or software module, which is not specifically limited herein.

It should be understood that the number of terminal devices, networks and servers in FIG. 1 is merely illustrative. Depending on the implementation needs, there may be any number of terminal devices, networks and servers.

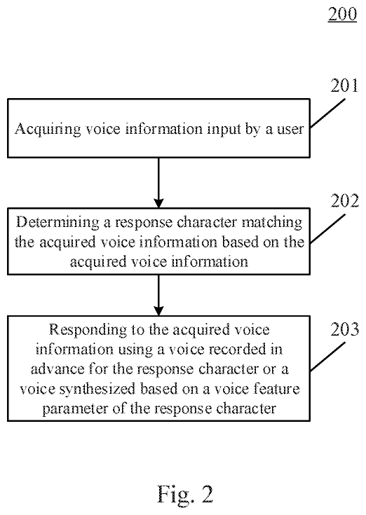

With further reference to FIG. 2, a flow 200 of a method for voice interaction according to an embodiment of the present disclosure is illustrated. The method for voice interaction includes the following steps.

Step 201, acquiring voice information input by a user.

In the present embodiment, an executing body of the method for voice interaction (for example, the server or terminal shown in FIG. 1) may first acquire the voice information input by the user. The executing body may be any device that provides an intelligent voice interaction service. Intelligent voice interaction is a human-computer interaction mode of a new generation based on voice input, and people may obtain feedback information by speaking. Generally, people may use a smart voice device capable of implementing intelligent voice interaction to obtain corresponding feedback information by inputting voice to the smart voice device. A smart voice device (for example, a smart speaker) may provide voice services for a plurality of users, and the executing body may acquire the voice information input by the user through a voice acquiring apparatus such as a microphone.

Step 202, determining a response character matching the acquired voice information based on the acquired voice information.

In the present embodiment, the executing body may determine the response character matching the acquired voice information based on the voice information acquired in step 201. For a voice interaction device, since it is necessary to respond to the user in voice, there is a system speaker, that is, a response character, and the response character may be a virtual character that provides a voice response. Since the response character has a strong perception of the user, the user may generate certain emotional cognition to the system and generate emotions such as preference or boredom. Therefore, the response character has a great impact on the user experience of the voice interaction device.

The executing body may store preset voices recorded for various response characters and attribute data of the response characters, and the attribute data may include “avatar”, “name”, “date of birth”, “gender”, “character description”, “TTS (Text to Speech) tone,” “art of speaking” and so on. The TTS tone may be the speaker tone of the device for voice response, and the art of speaking may be the way of speaking and the speaking style of the device for voice response. As an example, the response character may include a response character 1 and a response character 2, the response character 1 may be a girl tone, having a cute character and fast speech rate, and the response character 2 may be a boy tone, having a calm character and slow speech rate.

In the present embodiment, the response character matching the acquired voice information may be a response character voluntarily selected by the user or a response character automatically recommended by the executing body. The executing body may display attribute information of a preset response character and/or play a voice pre-recorded or synthesized for the response character for the user to select, or may recommend a response character for the user based on attribute information of the user or randomly, and then use the response character selected by the user or the response character recommended for the user as the response character matching the acquired voice information. In addition, the user may also enter attribute information of a response character and/or input a voice of a response character voluntarily to modify or increase a response character.

In some alternative implementations of the present embodiment, the determining a response character matching the acquired voice information based on the acquired voice information, includes: determining identification information of the user based on the acquired voice information; querying a response character corresponding to the determined identification information in a response character setting record representing a corresponding relationship between identification information and response characters; and determining the queried response character as the response character matching the acquired voice information.

In some alternative implementations of the present embodiment, the determining a response character matching the acquired voice information based on the acquired voice information, includes: determining the response character corresponding to the recognized name as the response character matching the acquired voice information, in response to recognizing that the acquired voice information includes a name defined in advance for a response character.

This implementation enables the user to select a response character by saying the name of the response character, further enriching the voice interaction method. In this implementation, the executing body may convert the voice information into a text, determine whether the text includes the name defined in advance for the response character, or directly compare the voice information with the voice of the name of the response character. The name of the response character may be either system default or set by the user.

In some alternative implementations of the present embodiment, the name defined in advance for a response character includes a voice interaction wake-up word. The voice interaction wake-up word is a word that makes the device being in a sleep state to enter a state of waiting for an instruction.

Step 203, responding to the acquired voice information using a voice recorded in advance for the response character or a voice synthesized based on a voice feature parameter of the response character.

In the present embodiment, the executing body may respond to the acquired voice information using the voice recorded in advance for the response character determined in step 202 or the voice synthesized based on the voice feature parameter of the response character determined instep 202. The voice recorded in advance for the response character may be acquired by selecting the voice of a person matching the attribute information of the response character, or may be the voice recorded by a voice actor who uses a voice matching the attribute information of the response character. For example, if the response character is 18-year-old girl, an 18-year-old girl may be asked to record. Voice synthesis may be performed using the TTS technology or using a pre-trained voice synthesis model. The voice feature parameter may include: spectrum, fundamental frequency, duration, pitch, length, intensity, etc., and may also include parameters of the voice synthesis model that is pre-trained for the response character.

The above voice synthesis model may include a plurality of neural networks sequentially connected from bottom to top. The neural network in each neural network corresponding to each voice synthesis model corresponds to a layer of the neural network corresponding to the voice synthesis model. For example, the neural network corresponding to the voice synthesis model includes a plurality of sequentially connected DNNs from bottom to top, and each DNN corresponds to one layer. On top of the layer where the last DNN is located, it contains a plurality of RNNs, and each RNN corresponds to one layer. A training sample of the voice synthesis model contains a text and a voice corresponding to the text.

In some alternative implementations of the present embodiment, the responding to the acquired voice information using a voice recorded in advance for the response character or a voice synthesized based on a voice feature parameter of the response character, includes: converting the acquired voice information into a text; determining a response text based on the converted text and a voice response logic preset for the response character; and responding to the acquired voice information, using a voice recorded in advance for the response character and containing the response text, or a voice synthesized based on the voice feature parameter of the response character and the response text.

In this implementation, a response text is determined through the voice response logic preset for the response character, so that the response voice is more targeted. In this implementation, the executing body may perform voice recognition on the voice information to obtain text information corresponding to the voice information. Then, various semantic analysis methods (for example, word segmentation, part-of-speech tagging, and named entity recognition) may be used to analyze the text information, thereby obtaining semantics corresponding to the text information, and finally determining the response text matching the semantics. The voice response logic may include a corresponding relationship between the text converted from the acquired voice information and the response text. For example, the response character is a girl having a playful character, and the text converted from the acquired voice information is “Please play a song”, then the response text may be “I guess you want to listen to this song”. The response character is a middle-aged person with a calm personality, and the text converted from the acquired voice information is “Please play a song”, then the response text may be “OK, please listen to this song”.

The method for voice interaction provided by the above embodiment of the present disclosure, by acquiring voice information input by a user, then determining a response character matching the acquired voice information based on the acquired voice information, and finally responding to the acquired voice information using a voice recorded in advance for the response character or a voice synthesized based on a voice feature parameter of the response character, provides a voice interaction mechanism for determining a response character based on voice information, and enriches the voice interaction method.

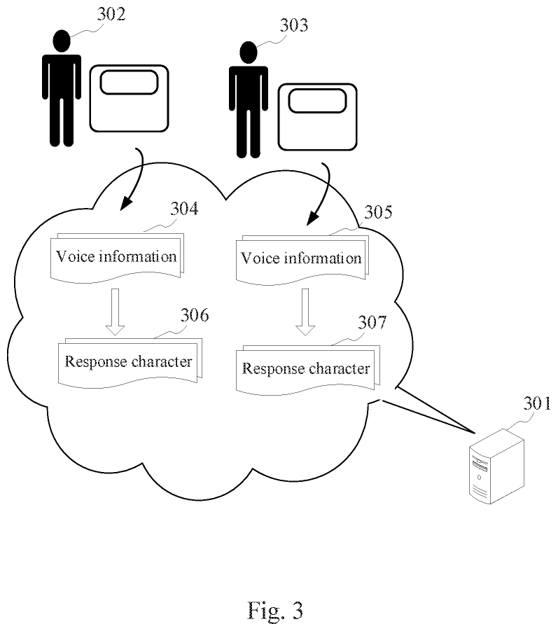

With further reference to FIG. 3, FIG. 3 is a schematic diagram of an application scenario of the method for voice interaction according to an embodiment. In the application scenario of FIG. 3, a server 301 acquires voice information 304 input by a user 302 through a smart screen player, and voice information 305 input by a user 303 through the smart screen speaker, then determines a response character 306 matching the voice information 304 based on the voice information 304, and determines a response character 307 matching the voice information 305 based on the voice information 305, finally responds to the voice information 304 using a voice recorded in advance for the response character 306 or a voice synthesized based on the voice feature parameter of the response character 306, and responds to the voice information 305 using a voice recorded in advance for the response character 307 or a voice synthesized based on the voice feature parameter of the response character 307.

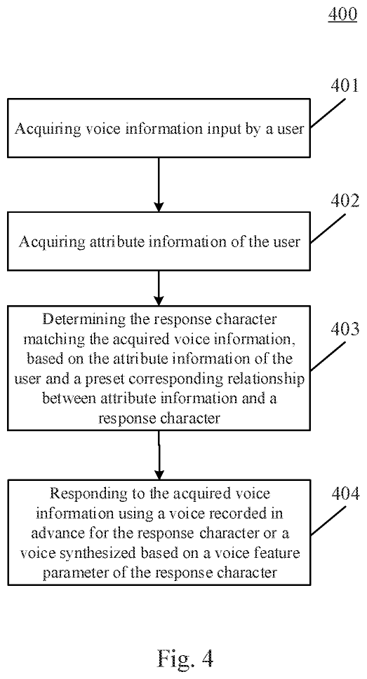

With further reference to FIG. 4, a flow 400 of the method for voice interaction according to another embodiment of the present application is illustrated. The flow 400 of the method for voice interaction includes the following steps.

Step 401, acquiring voice information input by a user.

In the present embodiment, an executing body of the method for voice interaction (for example, the server or terminal shown in FIG. 1) may first acquire the voice information input by the user.

Step 402, acquiring attribute information of the user.

In the present embodiment, the executing body may acquire the attribute information of the user who inputs the voice information in step 401. The attribute information may include age, gender, occupation, hobby, etc. According to the attribute, the user may be divided into: child user, youth user, middle-aged user and elderly user, male user, female user, etc.

In some alternative implementations of the present embodiment, the acquiring attribute information of the user, includes: performing voiceprint recognition on the acquired voice information, and determining the attribute information of the user based on a recognition result. Voiceprint is a sound wave spectrum that carries voice information displayed together with electroacoustics. The acoustic characteristics of the user may be extracted from the voiceprint. Voiceprint recognition, is a type of biometric technology. Voiceprint recognition may extract the acoustic characteristics of a speaker by the voice, discriminate the speaker's identity based on the acoustic characteristics, and determine the attribute information of the speaker such as a corresponding age group.

Taking the attribute information being age as an example, people of the same age group may have relatively approximate physiological characteristics, so that people of the same age group may have similar acoustic characteristics. A characteristic parameter interval corresponding to a common acoustic characteristic of multiple users of each age group may be counted in advance. The above voiceprint recognition may include characteristic values of the user's acoustic characteristics extracted from the user's voice information. Then, the characteristic values of the extracted acoustic characteristics of the user are compared with the characteristic parameter intervals of the pre-extracted acoustic characteristics corresponding to various age groups. The age group corresponding to the characteristic parameter interval including the characteristic value of the acoustic characteristic of the user is used as the age group corresponding to the user. A user category of the user is then determined based on the determined age group corresponding to the user. The acoustic characteristic may include at least one of: duration, fundamental frequency, energy, formant frequency, wideband, frequency perturbation, amplitude perturbation, zero-crossing rate, or Mel frequency cepstral parameter.

In some alternative implementations of the present embodiment, the acquiring attribute information of the user, includes: determining identification information of the user based on the acquired voice information; and querying user attribute information corresponding to the identification information of the user in a pre-stored user information set. The executing body may determine the identification information of the user through the acoustic characteristics of the acquired voice information. If the acoustic characteristics match the acoustic characteristics of historically acquired voice information, it is determined that the identification information of the user is identification information matching the historically acquired voice information, and if the acoustic characteristics do not match the acoustic characteristics of the historically acquired voice information, it is possible to re-register a user.

Step 403, determining the response character matching the acquired voice information, based on the attribute information of the user and a preset corresponding relationship between attribute information and a response character.

In the present embodiment, the executing body may determine the response character matching the acquired voice information, based on the attribute information of the user acquired in step 402 and the preset corresponding relationship between the attribute information and the response character. As an example, if the attribute information indicates that the user is a child user, the voice feature parameter of the corresponding response character may be set to a voice feature parameter matching the child. Based on the voice feature parameter matching with the child user, a voice synthesized by the voice synthesis technology may sound the same or similar to a real child voice, thereby increasing the affinity of the response voice to the child user. Similarly, if the attribute information indicates that the user is an elderly user, the voice feature parameter of the corresponding response character may be set to the voice feature parameter of a voice statistically obtained to be preferred by the elderly users.

Step 404, responding to the acquired voice information using a voice recorded in advance for the response character or a voice synthesized based on a voice feature parameter of the response character.

In the present embodiment, the executing body may respond to the acquired voice information using the voice recorded in advance for the response character determined in step 403 or the voice synthesized based on the voice feature parameter of the response character determined in step 403.

In the present embodiment, the operations of the step 401 and step 404 are substantially the same as those of the step 201 and step 203, and detailed description thereof will be omitted.

As can be seen from FIG. 4, in the flow 400 of the method for voice interaction in the present embodiment, the response character matching the acquired voice information is determined by the attribute information of the user, as compared with the embodiment corresponding to FIG. 2. Therefore, the solution described in the present embodiment does not require manual setting by the user, thereby further improving the voice interaction efficiency.

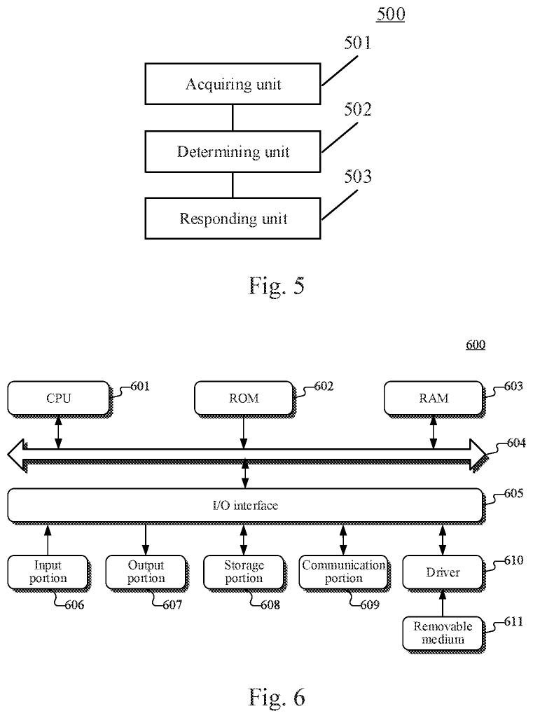

With further reference to FIG. 5, as an implementation of the method shown in the above figures, an embodiment of the present disclosure provides an apparatus for voice interaction, and the apparatus embodiment corresponds to the method embodiment as shown in FIG. 2, and the apparatus may be specifically applied to various electronic devices.

As shown in FIG. 5, an apparatus 500 for voice interaction of the present embodiment includes: an acquiring unit 501, a determining unit 502 and a responding unit 503. The acquiring unit is configured to acquire voice information input by a user. The determining unit is configured to determine a response character matching the acquired voice information based on the acquired voice information. The responding unit is configured to respond to the acquired voice information using a voice recorded in advance for the response character or a voice synthesized based on a voice feature parameter of the response character.

In the present embodiment, the specific processing of the acquiring unit 501, the determining unit 502, and the responding unit 503 of the apparatus 500 for voice interaction may refer to step 201, step 202, and step 203 in the corresponding embodiment of FIG. 2.

In some embodiments, the determining unit is further configured to: determine, in response to recognizing that the acquired voice information includes a name defined in advance for a response character the response character corresponding to the recognized name as the response character matching the acquired voice information.

In some embodiments, the name defined in advance for a response character includes a voice interaction wake-up word.

In some embodiments, the determining unit includes: an acquiring subunit, configured to acquire attribute information of the user; and a first determining subunit, configured to determine the response character matching the acquired voice information, based on the attribute information of the user and a preset corresponding relationship between attribute information and a response character.

In some embodiments, the acquiring subunit is further configured to: perform voiceprint recognition on the acquired voice information, and determine the attribute information of the user based on a recognition result.

In some embodiments, the acquiring subunit is further configured to: determine identification information of the user based on the acquired voice information; and query user attribute information corresponding to the identification information of the user in a pre-stored user information set.

In some embodiments, the responding unit includes: a converting subunit, configured to convert the acquired voice information into a text; a second determining subunit, configured to determine a response text based on the converted text and a voice response logic preset for the response character; and a responding subunit, configured to respond to the acquired voice information, using a voice recorded in advance for the response character and containing the response text, or a voice synthesized based on the voice feature parameter of the response character and the response text.

In some embodiments, the determining unit includes: a third determining subunit, configured to determine identification information of the user based on the acquired voice information; a querying subunit, configured to query a response character corresponding to the determined identification information in a response character setting record representing a corresponding relationship between identification information and response characters; and a fourth determining subunit, configured to determine the queried response character as the response character matching the acquired voice information.

The apparatus for voice interaction provided by the above embodiment of the present disclosure, by acquiring voice information input by a user, then determining a response character matching the acquired voice information based on the acquired voice information, and finally responding to the acquired voice information using a voice recorded in advance for the response character or a voice synthesized based on a voice feature parameter of the response character, provides a voice interaction mechanism for determining a response character based on voice information, and enriches the voice interaction method.

With further reference to FIG. 6, a schematic structural diagram of a computer system 600 adapted to implement a server or a terminal of the embodiments of the present disclosure is shown. The server or the terminal shown in FIG. 6 is merely an example, and should not impose any limitation on the function and scope of use of the embodiments of the present disclosure.

As shown in FIG. 6, the computer system 600 includes a central processing unit (CPU) 601, which may execute various appropriate actions and processes in accordance with a program stored in a read-only memory (ROM) 602 or a program loaded into a random access memory (RAM) 603 from a storage portion 608. The RAM 603 also stores various programs and data required by operations of the system 600. The CPU 601, the ROM 602 and the RAM 603 are connected to each other through a bus 604. An input/output (I/O) interface 605 is also connected to the bus 604.

The following components are connected to the I/O interface 605: an input portion 606 including such as a keyboard, a mouse; an output portion 607 including such as a cathode ray tube (CRT), a liquid crystal display device (LCD), a speaker, etc.; a storage portion 608 including a hard disk and the like; and a communication portion 609 including a network interface card, such as a LAN card and a modem. The communication portion 609 performs communication processes via a network, such as the Internet. A driver 610 is also connected to the I/O interface 605 as required. A removable medium 611, such as a magnetic disk, an optical disk, a magneto-optical disk, and a semiconductor memory, maybe installed on the driver 610, to facilitate the retrieval of a computer program from the removable medium 611, and the installation thereof on the storage portion 608 as needed.

In particular, according to the embodiments of the present disclosure, the process described above with reference to the flow chart may be implemented in a computer software program. For example, an embodiment of the present disclosure includes a computer program product, which includes a computer program that is tangibly embedded in a computer-readable medium. The computer program includes program codes for performing the method as illustrated in the flow chart. In such an embodiment, the computer program may be downloaded and installed from a network via the communication portion 609, and/or may be installed from the removable medium 611. The computer program, when executed by the central processing unit (CPU) 601, implements the above mentioned functionalities as defined by the method of the present disclosure. It should be noted that the computer readable medium in the present disclosure may be computer readable signal medium or computer readable storage medium or any combination of the above two. An example of the computer readable storage medium may include, but not limited to: electric, magnetic, optical, electromagnetic, infrared, or semiconductor systems, apparatus, elements, or a combination of any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fiber, a portable compact disk read only memory (CD-ROM), an optical memory, a magnet memory or any suitable combination of the above. In the present disclosure, the computer readable storage medium may be any physical medium containing or storing programs which may be used by a command execution system, apparatus or element or incorporated thereto. In the present disclosure, the computer readable signal medium may include data signal in the base band or propagating as parts of a carrier, in which computer readable program codes are carried. The propagating data signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

A computer program code for performing operations in the present disclosure may be compiled using one or more programming languages or combinations thereof. The programming languages include object-oriented programming languages, such as Java, Smalltalk or C++, and also include conventional procedural programming languages, such as C language or similar programming languages. The program code may be completely executed on a user's computer, partially executed on a user's computer, executed as a separate software package, partially executed on a user' s computer and partially executed on a remote computer, or completely executed on a remote computer or server.

In the circumstance involving a remote computer, the remote computer may be connected to a user's computer through any network, including local area network (LAN) or wide area network (WAN), or may be connected to an external computer (for example, connected through Internet using an Internet service provider).

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion including one or more executable instructions for implementing specified logic functions. It should also be noted that, in some alternative implementations, the functions denoted by the blocks may occur in a sequence different from the sequences shown in the accompanying drawings. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system performing specified functions or operations, or by a combination of a dedicated hardware and computer instructions.

The units involved in the embodiments of the present disclosure maybe implemented by means of software or hardware. The described units may also be provided in a processor, for example, maybe described as: a processor including an acquiring unit, a determining unit and a responding unit. Here, the names of these units do not in some cases constitute limitations to such units themselves. For example, the acquiring unit may also be described as “a unit configured to acquire voice information input by a user”.

In another aspect, the present disclosure further provides a computer readable medium. The computer readable medium may be included in the apparatus in the above described embodiments, or a stand-alone computer readable medium not assembled into the apparatus. The computer readable medium stores one or more programs. The one or more programs, when executed by the apparatus, cause the apparatus to: acquire voice information input by a user; determine a response character matching the acquired voice information based on the acquired voice information; and respond to the acquired voice information using a voice recorded in advance for the response character or a voice synthesized based on a voice feature parameter of the response character.

The above description only provides an explanation of the preferred embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the present disclosure. Technical schemes formed by the above-described features being interchanged with, but not limited to, technical features with similar functions disclosed in the present disclosure are examples.

What is claimed is:

1. A method for voice interaction, the method comprising:
acquiring voice information input by a user;
determining a response character matching the acquired voice information based on the acquired voice information; and
responding to the acquired voice information using a voice recorded in advance for the response character or a voice synthesized based on a voice feature parameter of the response character.

2. The method according to claim 1, wherein the determining a response character matching the acquired voice information based on the acquired voice information, comprises:
determining, in response to recognizing that the acquired voice information comprises a name defined in advance for a response character, the response character corresponding to the recognized name as the response character matching the acquired voice information.

3. The method according to claim 2, wherein the name defined in advance for the response character comprises a voice interaction wake-up word.

4. The method according to claim 1, wherein the determining a response character matching the acquired voice information based on the acquired voice information, comprises:
acquiring attribute information of the user; and
determining the response character matching the acquired voice information, based on the attribute information of the user and a preset corresponding relationship between attribute information and a response character.

5. The method according to claim 4, wherein the acquiring attribute information of the user, comprises:
performing voiceprint recognition on the acquired voice information, and determining the attribute information of the user based on a recognition result.

6. The method according to claim 4, wherein the acquiring attribute information of the user, comprises:
determining identification information of the user based on the acquired voice information; and
querying user attribute information corresponding to the identification information of the user in a pre-stored user information set.

7. The method according to claim 1, wherein the responding to the acquired voice information using a voice recorded in advance for the response character or a voice synthesized based on a voice feature parameter of the response character, comprises:
converting the acquired voice information into a text;
determining a response text based on the converted text and a voice response logic preset for the response character; and
responding to the acquired voice information, using a voice recorded in advance for the response character and containing the response text, or a voice synthesized based on the voice feature parameter of the response character and the response text.

8. The method according to claim 1, wherein the determining a response character matching the acquired voice information based on the acquired voice information, comprises:
determining identification information of the user based on the acquired voice information;
querying a response character corresponding to the determined identification information in a response character setting record representing a corresponding relationship between identification information and response characters; and
determining the queried response character as the response character matching the acquired voice information.

9. An apparatus for voice interaction, the apparatus comprising:
at least one processor; and
a memory storing instructions, wherein the instructions when executed by the at least one processor, cause the at least one processor to perform operations, the operations comprising:
acquiring voice information input by a user;
determining a response character matching the acquired voice information based on the acquired voice information; and
responding to the acquired voice information using a voice recorded in advance for the response character or a voice synthesized based on a voice feature parameter of the response character.

10. The apparatus according to claim 9, wherein the determining a response character matching the acquired voice information based on the acquired voice information, comprises:
determining, in response to recognizing that the acquired voice information comprises a name defined in advance for a response character, the response character corresponding to the recognized name as the response character matching the acquired voice information.

11. The apparatus according to claim 10, wherein the name defined in advance for the response character comprises a voice interaction wake-up word.

12. The apparatus according to claim 11, wherein the determining a response character matching the acquired voice information based on the acquired voice information, comprises:
acquiring attribute information of the user; and
determining the response character matching the acquired voice information, based on the attribute information of the user and a preset corresponding relationship between attribute information and a response character.

13. The apparatus according to claim 12, wherein the acquiring attribute information of the user, comprises:
performing voiceprint recognition on the acquired voice information, and determining the attribute information of the user based on a recognition result.

14. The apparatus according to claim 12, wherein the acquiring attribute information of the user, comprises:
determining identification information of the user based on the acquired voice information; and
querying user attribute information corresponding to the identification information of the user in a pre-stored user information set.

15. The apparatus according to claim 9, wherein the responding to the acquired voice information using a voice recorded in advance for the response character or a voice synthesized based on a voice feature parameter of the response character, comprises:
converting the acquired voice information into a text;
determining a response text based on the converted text and a voice response logic preset for the response character; and
responding to the acquired voice information, using a voice recorded in advance for the response character and containing the response text, or a voice synthesized based on the voice feature parameter of the response character and the response text.

16. The apparatus according to claim 9, wherein the determining a response character matching the acquired voice information based on the acquired voice information, comprises:
determining identification information of the user based on the acquired voice information;
querying a response character corresponding to the determined identification information in a response character setting record representing a corresponding relationship between identification information and response characters; and
determining the queried response character as the response character matching the acquired voice information.

17. A non-transitory computer readable medium, storing a computer program thereon, the program, when executed by a processor, implements the method according to claim 1.
